(19) United States
(12) Patent Application Publication
(10) Pub. No.: US 2026/0298165 A1
(43) Pub. Date: Oct. 1, 2026

(54) METHOD FOR CONTROLLING THE ROTATION OF A VEHICLE ENGINE CAMSHAFT

(71) Applicant: SCHAEFFLER TECHNOLOGIES AG & CO. KG, Herzogenaurach (DE)

(72) Inventors: Stéphane ELOY, Tournefeuille (FR); Fabien JOSEPH, Castanet Tolosan (FR)

(73) Assignee: SCHAEFFLER TECHNOLOGIES AG & CO. KG, Herzogenaurach (DE)

(21) Appl. No.: 19/549,248

(22) Filed: Feb. 25, 2026

(30) Foreign Application Priority Data
Mar. 26, 2025 (FR) FR2503102

(51) Int. Cl. F02D 41/00; F02D 41/14

(52) U.S. Cl. CPC F02D 41/009; F02D 41/1401; F02D 2041/1433; F02D 2250/06

(57) ABSTRACT

A method for controlling the rotation of a camshaft of an engine of a vehicle. The engine including a camshaft and an angular-position measurement sensor. The method includes the steps of detection, by a sensitive element, of the passage of an edge, determination of an identification time interval corresponding to the duration separating successive edges in the generated signal, calculation of an identification ratio, calculation of a theoretical reverse ratio in which the determined identification time interval is replaced by a reverse time interval stored in memory, comparison between the identification ratio, the nominal ratio and the reverse ratio, and detection of a reverse rotation of the camshaft if the identification ratio is closer to the reverse ratio.

### CROSS REFERENCE TO RELATED APPLICATION

This application claims priority to France Application No. FR2503102, filed Mar. 26, 2025, the contents of such application being incorporated by reference herein.

### FIELD OF THE INVENTION

The present invention relates to the field of vehicle engines and relates more particularly to a method for controlling the rotation of a camshaft in an internal combustion engine.

### BACKGROUND OF THE INVENTION

The internal combustion engines with which most thermal motor vehicles are equipped work by injecting fuel into a plurality of chambers and igniting it. The resultant explosion drives pistons which turn a crankshaft which transmits the torque thus generated. It is necessary for the rotation of the crankshaft always to be in the one same direction referred to as the “nominal direction”.

On engine-start and at high speed, because the pistons are actuated by the starter and/or because of the rotational inertia of the crankshaft, the pistons drive the crankshaft in the nominal direction without said crankshaft being able to change direction of rotation.

By contrast, as is known, the stopping of the engine, for example when the engine stalls, may cause the crankshaft and the camshaft to reverse direction of rotation. Such reversal may cause the engine-cycle strokes to become unsynchronized, and this may lead to engine damage.

It is therefore necessary to detect this reverse rotation as swiftly as possible in order to interrupt the injection of fuel so as to prevent unsynchronized combustion of fuel from causing damage to the engine.

One known solution is to use a sensor to determine the angular position of the crankshaft so as to detect reversal of the rotation thereof.

The angular-position sensor comprises a toothed target, secured to the shaft, and a fixed sensitive element positioned some distance away facing the target.

Given the importance of preventing combustion if the rotation of the crankshaft reverses, it is known practice to provide redundancy in the measurement by using a second angular-position sensor for the camshaft.

In one conventional embodiment, the toothed target comprises a low number of teeth, generally between three and sixteen, these teeth having uneven angular lengths to make it possible to identify the angular position of the shaft and determine the state of the engine cycle. Each tooth of the target has a leading edge, namely the first edge in the nominal direction of rotation, and a trailing edge. The angular-position sensor emits a signal the variations of which represent the leading edges and/or the trailing edges.

By comparing the time intervals measured at predetermined intervals, the angular-position sensor is able to detect reversal of the rotation of the camshaft, and therefore of the crankshaft, if the time interval between a given two successive edges differs from that expected.

However, when the rotation of the toothed target reverses, the sensor is sometimes unable to identify the reversal of the rotation immediately. Specifically, immediately after the reversal of the rotation, the last edge that the sensor detected in the nominal direction of rotation may move back past the sensor after a time that is substantially similar to the time at which the next edge should have passed.

In such instances, the sensor is unable to identify the reversal of the rotation of the crankshaft immediately and, if combustion is maintained, there is then a significant risk of damaging the engine.

Therefore, there is a need for a simple and effective solution allowing at least some of these drawbacks to be overcome.

### SUMMARY OF THE INVENTION

To this end, an aspect of the invention relates first of all to a method for controlling the rotation of a camshaft of an engine of a vehicle, notably for an internal combustion engine of an automotive vehicle, said vehicle comprising said engine, said engine comprising a camshaft and an angular-position measurement sensor, said camshaft being configured to be rotated in a direction referred to as nominal, said nominal direction of rotation being the opposite of a direction of rotation said to be the “reverse” direction, said measurement sensor comprising:
a toothed target, fixed to the camshaft and comprising on its periphery a plurality of teeth having uneven angular lengths, each tooth having a leading edge and a trailing edge,
a sensitive element, configured to emit a signal the variations of which are indicative of the passage of the leading edges and of the trailing edges of the teeth, and
an electronic control unit containing, in memory, for each edge of the toothed target, a set of predetermined “nominal” time intervals, a set of nominal ratios and at least one “reverse” time interval which has been predetermined from a theoretical model of the speed of reverse rotation of the camshaft, said model having been created in advance using measurements from a camshaft of a calibration engine rotating in the reverse direction, said method comprising the steps of:
passage of an edge of a tooth of the toothed target past the sensitive element,
detection, by the sensitive element, of the passage of said edge,
generation, by the sensitive element, of a signal indicative of the detected passage of the edge,
determination, by the electronic control unit, of an identification time interval corresponding to the duration separating two successive edges in the generated signal,
calculation, by the electronic control unit, of an identification ratio from at least one predetermined identification time interval,
determination, by the electronic control unit, of the theoretical edge corresponding to the detected passage of the signal edge on the basis of the last edge validated during the preceding iteration of the method,
calculation, by the electronic control unit, of a theoretical “reverse” ratio, from a plurality of nominal time intervals and from the at least one reverse time interval stored in memory,
comparison, by the electronic control unit, between the calculated identification ratio, the nominal ratio corresponding to the theoretical edge and the reverse ratio,
if the identification ratio is closer to the expected nominal ratio than to the reverse ratio, validation of the nominal direction of rotation of the camshaft and validation of the edge,
if the identification ratio is closer to the reverse ratio than to the expected nominal ratio, detection, by the electronic control unit, of a reverse rotation of the camshaft and interruption of the injection of fuel into the engine.

The method according to an aspect of the invention thus makes it possible to detect a change in the behavior of the pistons by detecting the reversal of the rotation of the camshaft quickly and effectively and without the need to take measurements regarding the rotation of the crankshaft. The use of a model developed from measurements on a calibration engine camshaft rotating in the reverse direction makes it possible to obtain reverse time intervals that are closer to how the engine truly behaves when the camshaft reverses its direction of rotation and thus detect the reversal more representatively.

In one advantageous mode of operation, the electronic control unit contains in memory the edges liable to succeed a reversal of the direction of rotation of the camshaft, and the step of comparison between the calculated identification ratio, the nominal ratio corresponding to the theoretical edge and the reverse ratio, is performed only if the theoretical edge is an edge liable to succeed a reversal of the direction of rotation of the camshaft. The method is therefore quicker as it checks only some of the detected edges.

As a preference, the step of calculation, by the electronic control unit, of an identification ratio Rmes,n from a subset of the determined identification time intervals Tn, is performed on the basis of the determined identification time interval Tn and of the three identification times Tn−1, Tn−2, Tn−3 determined in the three preceding iterations of the method, the identification ratio being calculated on the basis of the formula:

$${R}_{mes , n} = \frac{{T}_{n} + {T}_{n - 3}}{{T}_{n - 1} + {T}_{n - 2}} \qquad [ Math 1 ]$$

In this embodiment, the nominal ratio Rnom,n is calculated using the same expression, in which the identification time intervals Tn are replaced by the corresponding nominal time intervals Tnom,n.

The method according to an aspect of the invention is therefore performed from the fourth passage of an edge onward, so that the memory is able to contain the four time intervals needed for determining the measured ratio.

In this embodiment, the reverse ratio is calculated using the same expression, in which the identification time intervals Tn are replaced by the corresponding nominal time intervals Tnom,n.

Alternatively, the identification ratio Rmes,n, the nominal ratio Rnom,n and the reverse ratio Rinv,n may be calculated using other expressions. For example, the identification ratio Rmes,n may be equal or proportional to the identification time interval Tn, and the nominal ratio Rnom,n is then respectively equal or proportional to the nominal time interval Tnom,n and the reverse ratio is then respectively equal or proportional to the reverse time interval Tinv,n.

Advantageously, the theoretical model of the speed of reverse rotation of the camshaft is a sinusoidal periodic model in which the speed of the camshaft oscillates between a maximum speed determined from the calibration and a zero speed. The sinusoidal model is simple to implement and requires only the determination of a maximum speed to calibrate it. This calibration may be performed by measuring a maximum speed of rotation on the calibration engine or by averaging measured instantaneous speeds.

In this advantageous mode of operation, the engine comprises at least one piston and, with said at least one piston turning the camshaft, the zero speed corresponds to top dead center of the at least one piston. Because of the mechanics of the engine, piston top dead center, namely the position of the piston at the top of the chamber, corresponds, with one or more pistons, to the position at which the rotational speed of the camshaft is most likely to become nil.

As a variant, the theoretical model of the speed of reverse rotation of the camshaft is a non-periodic model, for example a parabola or hyperbola. These models may be more suitable depending on the measurements taken during calibration.

According to one aspect of the invention, the invention also relates to an electronic control unit for controlling an angular-position measurement sensor, said measurement sensor being configured to be mounted in a vehicle comprising an internal combustion engine, said engine comprising at least one camshaft, said electronic control unit comprising:
a toothed target, fixed to the at least one camshaft of the engine and comprising on its periphery a plurality of teeth having uneven angular lengths, each tooth having a leading edge and a trailing edge,
a sensitive element, configured to emit a signal the variations of which are indicative of the passage of the leading edges and of the trailing edges of the teeth,
said electronic control unit containing, in memory, for each edge of the toothed target, a set of predetermined “nominal” time intervals, a set of nominal ratios and at least one “reverse” time interval which has been predetermined from a theoretical model of the speed of reverse rotation of the camshaft, said model having been created in advance using measurements from a camshaft of a calibration engine rotating in the reverse direction, and said control unit being configured to:
receive the signal the variations of which are indicative of the passage of the leading edges and of the trailing edges of the teeth,
determine an identification time interval between two successive edges and to store said identification time interval in memory,
determine a theoretical edge corresponding to a variation in the received signal,
calculate an identification ratio from a plurality of determined time intervals,
calculate a reverse ratio from a plurality of nominal time intervals and from a reverse time interval stored in memory,
compare the identification ratio against the nominal ratio and against the reverse ratio,
validate the nominal direction of rotation of the camshaft and the edge when the identification ratio is closer to the expected nominal ratio than to the reverse ratio,
detect a reverse rotation of the camshaft and interrupt the injection of fuel into the engine when the identification ratio is closer to the reverse ratio than to the expected nominal ratio.

As a preference, the electronic control unit contains in memory the edges liable to succeed a reversal of the direction of rotation of the camshaft, and calculates a reverse ratio only if the expected edge is liable to succeed a reversal of the direction of rotation of the camshaft. The electronic control unit is therefore able to economize on computation time.

In this preferred embodiment, the electronic control unit contains in memory a reverse time interval for each edge liable to succeed reversal of the direction of rotation of the camshaft and is configured to calculate the reverse ratio for an edge from the reverse time corresponding to said edge. These times enable the control method to be adapted and make it possible to take into account reversals in the rotation of the camshaft and of the crankshaft which have been triggered by the speed dropping to nil at top dead center for each piston.

Another aspect of the invention relates to an angular-position measurement sensor for a vehicle comprising an internal combustion engine comprising at least one camshaft, said measurement sensor comprising:
a toothed target, fixed to the at least one camshaft of the engine and comprising on its periphery a plurality of teeth having uneven angular lengths, each tooth having a leading edge and a trailing edge,
a sensitive element, configured to emit a signal the variations of which are indicative of the passage of the leading edges and of the trailing edges of the teeth, and
an electronic control unit such as described above.

Another aspect of the invention relates to a vehicle, notably automotive vehicle, comprising an internal combustion engine, said internal combustion engine comprising at least one camshaft and an angular-position measurement sensor as described above.

### BRIEF DESCRIPTION OF THE DRAWINGS

Other features and advantages of aspects of the invention will become more apparent from reading the description that follows. This description is purely illustrative and should be read in conjunction with the appended drawings, in which:

FIG. 1 illustrates an example of an automotive vehicle comprising an internal combustion engine.

FIG. 2 schematically illustrates an exploded view of an internal combustion engine.

FIG. 3 schematically illustrates an operating cycle of an internal combustion engine.

FIG. 4 schematically illustrates an angular-position measurement sensor for a camshaft.

FIG. 5 schematically illustrates a face-on view of the toothed target of the angular-position measurement sensor.

FIG. 6 illustrates a table illustrating the various ratios determined during the method with and without taking account of a reverse rotation of the pistons.

FIG. 7 schematically illustrates the steps of the method for synchronizing the injection of fuel according to an aspect of the invention.

### DESCRIPTION OF THE EMBODIMENTS

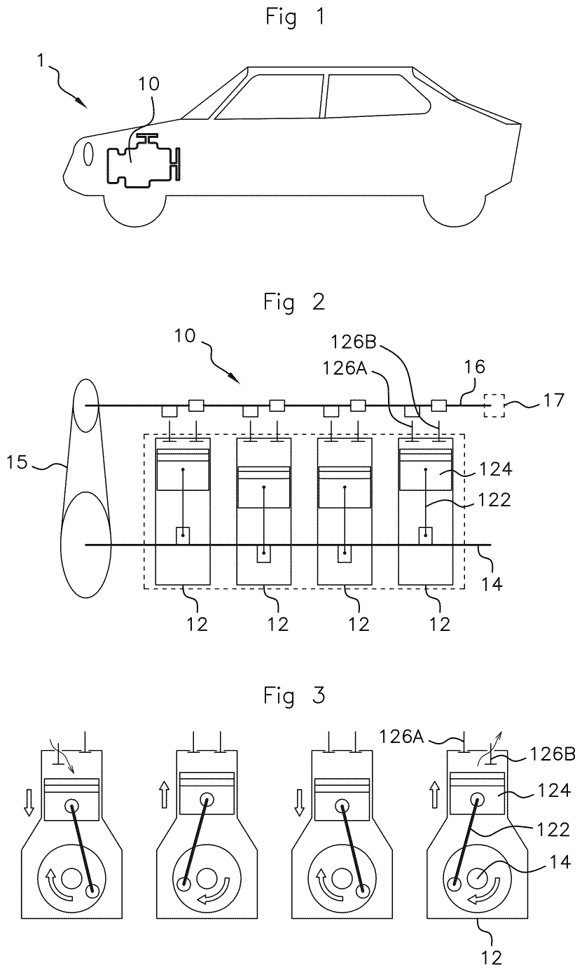

The method according to an aspect of the invention is implemented on a vehicle 1 comprising an internal combustion engine 10 as depicted in FIG. 1.

### Vehicle 1

As depicted in FIG. 1, the vehicle 1 is an automotive vehicle comprising an internal combustion engine 10.

In other forms of embodiment, the vehicle 1 may be any type of vehicle comprising an internal combustion engine 10, such as a two-wheeled vehicle, a heavy-duty vehicle, a bus, etc.

### Engine 10

The engine 10 is an internal combustion engine that powers the vehicle 1 by burning fuel.

The fuel may be gasoline, diesel oil or ethanol.

As depicted in FIG. 2, the engine 10 comprises a plurality of combustion chambers 12, a crankshaft 14, a timing belt 15, a camshaft 16 and an angular-position measurement sensor 17.

In alternative forms of embodiment of the engine 10, the timing belt 15 may be replaced by a chain or gears.

As depicted in FIG. 2, each chamber 12 comprises a connecting rod 122, a piston 124 and two valves 126A and 126B.

The valve 126A is an inlet valve, the opening of which allows air to be admitted into the chamber 12.

The valve 126B is an exhaust valve, the opening of which allows the gases produced by the combustion to be exhausted.

An injector (for the sake of clarity this is not depicted in the figures) allows fuel to be injected into the chamber 12. Depending on the type of engine 10, the injector may inject the fuel directly into the chamber 12 in the case of direct injection, or else inject it upstream of the inlet valve 126A or into a pre-combustion chamber or combustion pre-chamber connected to the chamber 12, in the case of indirect injection.

The piston 124 moves with rectilinear motion in the chamber 12 between the top and the bottom of the chamber 12 between top dead center and a bottom dead center and vice versa.

The connecting rod 122 connects the piston 124 to the crankshaft 14. The rectilinear motion of the piston 124 is transmitted to the crankshaft 14, turning it.

The crankshaft 14 turns the driven wheels of the vehicle 1 by transmitting the rotation generated by the combustion of the fuel.

The crankshaft 14 is connected to the camshaft 16 by the timing belt 15. The rotation of the crankshaft 14 is therefore transmitted to the camshaft 16.

When the engine 10 is operating correctly, all of the pistons 124 drive the crankshaft 14 and the camshaft 16 in the nominal direction of rotation. In the figures, this direction of rotation is the clockwise direction.

If the pistons 124 driving the crankshaft 14 reverse their direction of rotation (to the counterclockwise direction in the figures), the camshaft 16 is also driven in the reverse direction of rotation.

As a variant, the engine 10 may comprise two camshafts 16, the two camshafts 16 being driven by the rotation of the crankshaft 14.

The rotation of the camshaft 16 causes the opening and closing of the valves 126A, 126B.

As a preference, the camshaft 16 comprises a plurality of tappets or

followers that push against the valves 126A, 126B which then closes again under the effect of springs.

In the form of embodiment in which the engine 10 comprises two camshafts 16, the rotation of the first camshaft 16 provides for the opening and closing of the inlet valves 126A and the rotation of the second camshaft 16 provides for the opening of the exhaust valves 126B.

As a preference, the engine 10 is a four-stroke engine.

As depicted in FIG. 3, the first stroke is the intake stroke during which the valve 126A is open, the valve 126B is closed and the piston 124 is retreating toward the crankshaft 14. Air enters the chamber 12.

The second stroke corresponds to compression. The valve 126A is closed at the end of the intake stroke, the valve 126B is still closed and the piston 124 advances into the chamber 12, compressing the gaseous mixture resulting from the injection of air and of fuel.

The injection of fuel into the chamber 12 may be performed during the intake stroke or during the compression stroke depending on the type of engine 10 and on the type of fuel (gasoline, diesel oil, or other) used.

The third stroke is the combustion stroke in which the fuel-air mixture in the chamber 12 ignites at the end of compression. The valves 126A and 126B are closed, and combustion may be brought about by a spark depending on the type of engine 10 and of fuel. The energy released by the combustion drives the piston 124 toward the bottom of the chamber 12, turning the crankshaft 14.

The fourth stroke is the exhaust stroke. The valve 126B opens and the piston 124 advances into the chamber 12. The valve 126A is closed and the movement of the piston 124 drives the gases resulting from the combustion out of the chamber 12 via the valve 126B.

One cycle therefore corresponds to two revolutions of the crankshaft 14 and to the piston 124 passing twice through top dead center.

On start-up, injection needs to be synchronized so that it is performed during the stroke (intake or compression) corresponding to the type of engine 10 used and to the type of fuel.

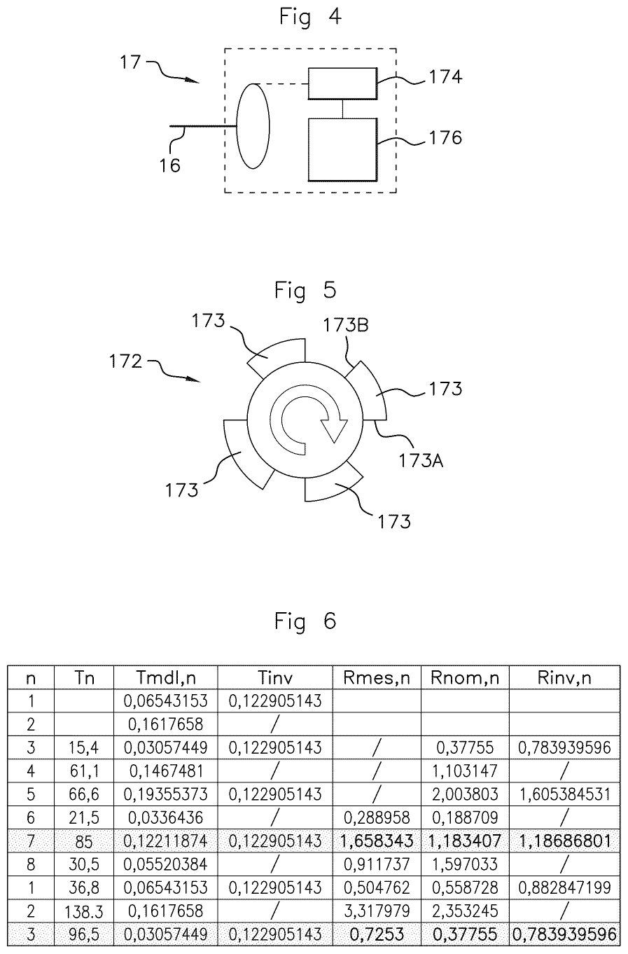

As depicted in FIG. 4, the measurement sensor 17 comprises a toothed target 172, a sensitive element 174 and an electronic control unit 176.

The toothed target 172 is fixed to one end of the camshaft 16 and on its periphery comprises a plurality of teeth 173.

For example, as depicted in FIG. 5, the toothed target 172 comprises four teeth 173.

Each tooth 173 has a leading edge 173A and a trailing edge 173B, the leading edge 173A being the first edge in the direction of rotation of the toothed target 172 and the trailing edge 173B being the second edge in the direction of rotation.

Returning to the example of FIG. 5, there are therefore eight edges, four leading edges 173A and four trailing edges 173B. It is possible to index each edge with a number n, as being the nth edge in the direction of rotation of the toothed target 172 counting from an edge arbitrarily set as being the reference edge.

The angular length of each tooth 173 is defined by the angle formed by the leading edge 173A and the trailing edge 173B.

The teeth 173 do not all have the same angular length. As depicted in FIG. 5, the toothed target comprises three teeth 173 of the same angular length, and one longer tooth 173.

The angular lengths separating two consecutive teeth 173 are also non-uniform.

The sensitive element 174 is positioned facing the toothed target 172 and detects the passage of the leading edges 173A and of the trailing edges 173B of the teeth 173.

The sensitive element 174 is preferably an active or passive magnetic-field sensor, or else a Hall-effect sensor.

As an alternative, the sensitive element 174 may be an optical sensor which detects the contrast between the presence and the absence of a tooth 173 or the interruption of a laser beam.

The sensitive element 174 may differentiate the passage of a leading edge 173A from the passage of a trailing edge 173B assuming that the direction of rotation of the camshaft 16 is unidirectional.

The sensitive element 174 emits a continuous signal the variations of which are indicative of the passage of the leading edges 173A and of the trailing edges 173B of the teeth 173.

In addition or as an alternative, the sensitive element 174 may emit a variation in the specific signal upon the passage of a leading edge 173A that differs from the variation in the specific signal emitted upon the passage of a trailing edge 173B.

During normal operation of the engine 10, when the sensitive element 174 detects an edge, the edge detected next has to be the next edge in the direction of the rotation.

For example, when the sensitive element 174 detects the passage of the leading edge 173A of a tooth 173, the next edge detected has to be the trailing edge 173B of the same tooth 173.

However, if the direction of rotation of the camshaft 16 has reversed, the next stage detected by the sensitive element 174 is the same as the detected edge, which passes back past the sensitive element 174, because of the reversal of the rotation.

For example, if the crankshaft 14, and therefore the camshaft 16, reverses rotation after the leading edge 173A of one tooth 173 has passed but before the trailing edge 173B of this same tooth 173 has passed, the next detected edge is the same leading edge 173A.

The electronic control unit 176 is connected to the sensitive element 174 and receives the variations in the signal emitted by the sensitive element 174.

The electronic control unit 176 is configured to calculate and store in memory the identification time intervals Tn that separate the receipt of two consecutive edges.

The electronic control unit 176 is configured to perform calculations on the basis of the identification time intervals Tn stored in the memory.

The electronic control unit 176 is configured to calculate an identification ratio Rmes,n for each detection of an edge n.

If Tn is the last determined identification time interval, Tn−1, Tn−2 and Tn−3 are the three preceding measured time intervals, the identification ratio Rmes,n associated with the edge n is given by the formula:

$${R}_{mes , n} = \frac{{T}_{n} + {T}_{n - 3}}{{T}_{n - 1} + {T}_{n - 2}} \qquad [ Math 2 ]$$

The electronic control unit 176 comprises a memory zone which contains a set of “nominal” time intervals Tnom,n and a set of “nominal” ratios Rnom,n.

The nominal time intervals Tnom,n correspond to the expected time between the passage of two successive edges of the toothed target 172 during a nominal rotation of the camshaft 16.

For example, for the edge n, the time interval Tnom,n is the expected time interval between the detection of the edge n and the detection of the edge n−1.

Each edge n is associated with a nominal ratio Rnom,n, determined for an edge n using the nominal time interval Tnom,n and the three nominal intervals Tnom,n−1, Tnom,n−2, Tnom,n−3 of the three edges preceding the edge n.

The formula for calculating the nominal ratio Rnom,n is as follows:

$${R}_{nom , n} = \frac{{T}_{nom , n} + {T}_{nom , n - 3}}{{T}_{nom , n - 1} + {T}_{nom , n - 2}} \qquad [ Math 3 ]$$

The electronic control unit 176 contains a model of the angular speed of the camshaft 16.

This model is based on the behavior of the pistons 124 at low speed in the event that a change to the behavior of the pistons 124 causes the crankshaft 14 and the camshaft 16 to reverse rotation.

A very low engine speed renders it possible for the pistons 124 to stop in the very short space of time needed for the rotation to reverse.

Because of the inertia of the pistons 124 it is highly improbable that the pistons 124 will start to rotate in reverse if none of them is at top dead center. Specifically, reverse rotation happens when the inertia of the crankshaft 14 (and of a flywheel if any) becomes low and the piston 124 becomes incapable of compressing the air in the chamber 12 enough to move past top dead center.

The model, contained in memory, of the angular speed of the camshaft 16 therefore considers that the reverse speed of the camshaft 16 is zero at the moment the rotation reverses, which corresponds to the piston 124 being positioned top dead center.

More specifically, in this configuration that leads to a reversal of the direction of rotation of the crankshaft 14, the piston 124 reaches zero speed before top dead center, namely at an angle of rotation of the crankshaft 14 that is less than 360°, for example around 340°.

Taking tolerance factors into consideration makes it possible to maintain a simple model in which the dropping of the speed to nil corresponds to top dead center, the model, because of the calibration, remaining precise enough to be usable.

In one preferred embodiment, the model of the angular speed of the camshaft 16 during reverse rotation of the crankshaft 14 is given by a sinusoidal function that takes account of a maximum speed Vmax and of the number of pistons 124 in the engine 10:

$${V}_{inv} ( α ) = \frac{{V}_{max}}{2} ( 1 + sin ( \frac{N}{2} α ) ) \qquad [ Math 4 ]$$

The maximum speed Vmax can be determined by a calibration on a reference engine.

The model of the angular speed of the camshaft 16 contains the number N of pistons 124 in the engine 10. For an engine 10 comprising four chambers 12 and therefore four pistons 124, the model of the speed is given by:

$${V}_{inv} ( α ) = \frac{{V}_{max}}{2} ( 1 + sin ( 2 α ) ) \qquad [ Math 5 ]$$

In other embodiments, the model may be based on different functions, for example parabolas or more complex functions. The model does not have to be periodic because it does not seek to describe a full cycle of rotation of the camshaft 16.

By taking into account the sinusoidal model of the speed of the camshaft 16 during one rotation, the electronic control unit 176 contains, in memory, modeled time intervals separating the successive passage of the one same edge of a tooth 173 of the toothed target 172.

The reverse time interval Tinv,n corresponding to the edge n therefore corresponds to the time separating detection of the edge n during normal rotation from the re-detection of that same edge n in reverse rotation, assuming that the camshaft 16 has reversed rotation between these two events.

As a preference, the reverse time intervals Tinv,n are determined only for the edges likely to be followed by a top dead center of one of the pistons 124, and therefore where there is the potential for rotation to be reversed.

The electronic control unit 176 contains, in memory, for each stored reverse time interval Tinv,n, a ratio referred to as “reverse ratio”, denoted Rinv,n, and involving the reverse time intervals Tinv,n and the nominal time intervals Tnom,n−1, Tnom,n−2 and Tnom,n−3.

The reverse ratio Rinv,n is calculated using the formula:

$${R}_{inv , n} = \frac{{T}_{inv , n} + {T}_{nom , n - 3}}{{T}_{nom , n - 1 +} {T}_{nom , n - 2}} \qquad [ Math 6 ]$$

The electronic control unit 176 is configured to compare, for a given edge n, the identification ratio Rmes,n, the nominal ratio Rnom,n and the reverse ratio Rinv,n and to determine whether the identification ratio Rmes,n is closer to the nominal ratio Rnom,n or to the reverse ratio Rinv,n.

FIG. 6 depicts the measured ratios Rmes,n, the nominal ratios Rnom,n and the reverse ratios Rinv,n for a toothed target 172 comprising eight edges 173A, 173B. The measured ratios Rmes,n are calculated on the basis of measured identification time intervals Tn, and the nominal ratios Rnom,n and the reverse ratios Rinv,n are calculated on the basis of the predetermined nominal time intervals and of the reverse time intervals Tinv,n calculated on the basis of the sinusoidal model of the rotational speed of the camshaft 16.

The electronic control unit 176 is configured to command interruption of the injection of fuel into the engine 10.

### Example of Implementation

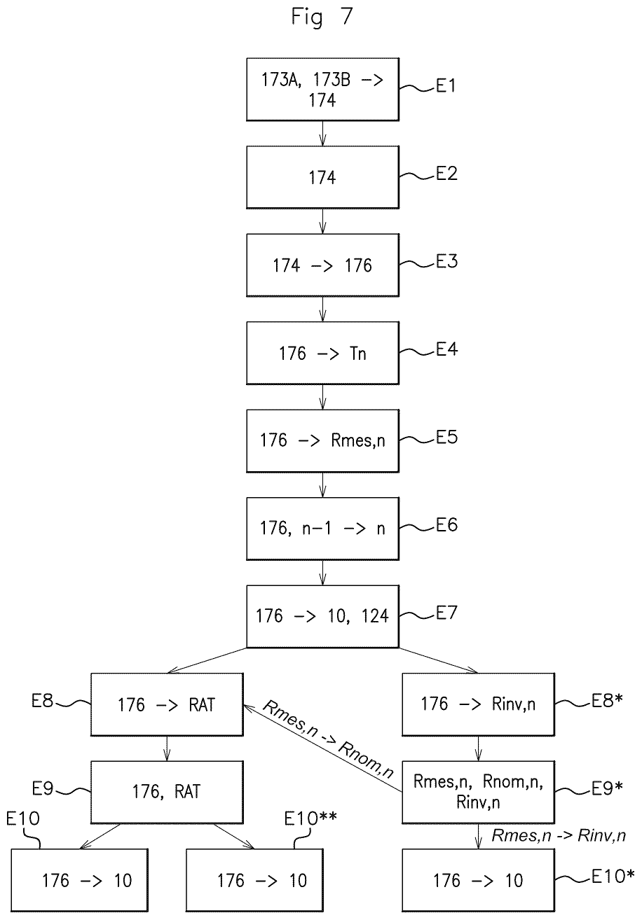

The method according to an aspect of the invention, depicted in FIG. 7, is carried out each time an edge of a tooth 173 of the toothed target 172 passes past the sensitive element 174.

In a first step E1, an edge of a tooth 173 of the toothed target 172 passes past the sensitive element 174.

In a second step E2, the sensitive element 174 detects the passage of the edge and in a step E3 emits a variation in the signal which is sent to the electronic control unit 176.

In a step E4, the electronic control unit 176 receives the signal emitted by the sensitive element 174 and detects the variation in the signal and determines the identification time interval Tn separating its receipt from the variation of the preceding signal.

During this step, the identification time interval Tn determined is stored in memory by the electronic control unit 176.

In a step E5, the electronic control unit 176 calculates an identification ratio Rmes,n for each detected edge, using the formula set out hereinabove.

In a step E6, the electronic control unit 176 determines, on the basis of the edge confirmed in the preceding iteration, which is the edge expected during the iteration currently in progress.

For example, if the edge confirmed in the preceding iteration is the edge n−1, the edge expected during the current iteration is the edge n.

In a step E7, the electronic control unit 176 determines whether the edge expected during the iteration currently in progress is an edge liable to follow a reversal of the rotation of the direction of motion of the pistons 124.

If the electronic control unit 176 determines that the edge expected during the current iteration is not an edge likely to follow a reversal of the rotation of the direction of motion of the pistons 124, the electronic control unit 176 in a step E8 calculates the ratio RAT between the identification ratio Rmes,n and the nominal ratio Rnom,n associated with the edge n.

In a step E9, the electronic control unit 176 compares the value of the calculated ratio RAT with a predetermined interval.

If the value of the ratio RAT lies within the predetermined interval, the electronic control unit 176 in a step E10 validates that the edge detected is the edge n expected.

As the engine 10 continues to operate, a new edge passes past the sensitive element 174, triggering a further iteration of the method.

If the value of the ratio RAT lies outside of the predetermined interval, the edge detected does not correspond to the edge expected and the electronic control unit 176 in a step E10** detects a fault.

In that case, the electronic control unit 176 triggers the stopping of the injection so as to avoid aggravating the problem with the engine 10, and the method is interrupted.

If, in the step E7, the electronic control unit 176 determines that the edge expected during the current iteration is an edge likely to follow a reversal of the rotation of the piston 124, the electronic control unit 176 in a step E8* calculates the reverse ratio Rinv,n associated with the edge n, using the formula [Math 4].

In a step E9*, the electronic control unit 176 compares the identification ratio Rmes,n, the nominal ratio Rnom,n associated with the edge n and the reverse ratio Rinv,n associated with the edge n.

If the identification ratio Rmes,n is closer to the nominal ratio Rnom,n than to the reverse ratio Rinv,n, the electronic control unit 176 determines that there has been no reversal of the direction of rotation of the camshaft 16 and resumes the method from step E8.

If the identification ratio Rmes,n is closer to the reverse ratio Rinv,n than to the nominal ratio Rnom,n, the electronic control unit 176, in a step E10*, determines that there has been a reversal of the direction of rotation of the camshaft 16.

The electronic control unit 176 then triggers the stopping of the injection into the chambers 12 of the engine 10, and the method is interrupted.

As depicted in the example of FIG. 6, the identification ratio Rmes,3 is closer to the reverse ratio Rinv,3 than to the nominal ratio Rnom,3, thus indicating that the edge detected is not the edge 3 expected but the edge 2 which has been re-detected by the sensitive element 174. A reversal of the rotation of the camshaft 16 is therefore detected.

The method according to an aspect of the invention thus makes it possible to control the rotation of the crankshaft 14 of the engine 10 using only measurements from the camshaft 16, in a way that is simple and quick and that takes into account a theoretical model of the operation of the engine 10. This model makes it possible to take into account the scenarios in which a change in the behavior of the pistons 124 leads to a reversal in the rotation of the camshaft 16 such that the identification time interval Tn calculated between the passage of the one same edge before and after the reversal of the rotation is close to the correct time interval that would have been measured during a nominal rotation. This refined detection of a reversal of rotation allows more robust injection cut-off in order to avoid significant damage to the engine 10.

1. A method for controlling the rotation of a camshaft of an internal combustion engine of an automotive vehicle, said vehicle comprising said engine, said engine comprising a camshaft and an angular-position measurement sensor, said camshaft being configured to be rotated in a direction referred to as nominal, said nominal direction of rotation being the opposite of a direction of rotation said to be the “reverse” direction, said measurement sensor comprising:
a toothed target, fixed to the camshaft and comprising on its periphery a plurality of teeth having uneven angular lengths, each tooth having a leading edge and a trailing edge,
a sensitive element, configured to emit a signal the variations of which are indicative of the passage of the leading edges and of the trailing edges of the teeth, and
an electronic control unit containing, in memory, for each edge of the toothed target, a set of predetermined “nominal” time interval (Tnom,n), a set of nominal ratios (Rnom,n) and at least one “reverse” time interval (Tinv,n), these having been predetermined from a theoretical model of the speed of reverse rotation of the camshaft, said model having been created in advance using measurements from a camshaft of a calibration engine-rotating in the reverse direction,
said method comprising the steps of:
passage (E1) of an edge of a tooth of the toothed target past the sensitive element,
detection (E2), by the sensitive element, of the passage of said edge,
generation (E3), by the sensitive element, of a signal indicative of the detected passage of the edge,
determination (E4), by the electronic control unit, of an identification time interval (Tn) corresponding to the duration separating two successive edges in the generated signal,
calculation (E5), by the electronic control unit, of an identification ratio (Rmes,n) from at least one predetermined identification time interval (Tn),
determination (E6), by the electronic control unit, of the theoretical edge corresponding to the detected passage of the signal edge on the basis of the last edge validated during the preceding iteration of the method,
calculation (E8*), by the electronic control unit, of a theoretical “reverse” ratio (Rinv,n), from a plurality of nominal time intervals and from the at least one reverse time interval (Tinv,n) stored in memory,
comparison (E9*), by the electronic control unit between the calculated identification ratio (Rmes,n), the nominal ratio (Rnom,n) corresponding to the theoretical edge and the reverse ratio (Rinv,n),
if the identification ratio (Rmes,n) is closer to the expected nominal ratio (Rnom,n) than to the reverse ratio (Rinv,n), validation (E10) of the nominal direction of rotation of the camshaft and validation of the edge,
if the identification ratio (Rmes,n) is closer to the reverse ratio (Rinv,n) than to the expected nominal ratio (Rnom,n), detection (E10*), by the electronic control unit of a reverse rotation of the camshaft and interruption of the injection of fuel into the engine.

2. The method according to claim 1, wherein the step (E5) of calculation, by the electronic control unit of an identification ratio (Rmes,n) from at least one predetermined identification time interval (Tn), is performed on the basis of the determined identification time (Tn) and of the three identification times (Tn−1, Tn−2, Tn−3) determined in the three preceding iterations of the method, the identification ratio (Rmes,n) being calculated on the basis of the formula Rmes,n=(Tn+Tn−3)/(Tn−1+Tn−2).

3. The method according to claim 1, wherein, the electronic control unit containing in memory the edges liable to succeed a reversal of the direction of rotation of the camshaft, the step (E9*) of comparison between the calculated identification ratio (Rmes,n), the nominal ratio (Rnom,n) corresponding to the theoretical edge and the reverse ratio (Rinv,n) is performed only if the theoretical edge is an edge liable to succeed a reversal of the direction of rotation of the camshaft.

4. The method according to claim 1, wherein the theoretical model of the speed of reverse rotation of the camshaft is a sinusoidal periodic model in which the speed of the camshaft oscillates between a maximum speed (Vmax) determined from the calibration and a zero speed.

5. The method according to claim 4, wherein, with the engine comprising at least one piston and said at least one piston turning the camshaft, the zero speed corresponds to top dead center of the at least one piston.

6. The method according to claim 1, wherein the theoretical model of the speed of reverse rotation of the camshaft is a non-periodic model, for example a parabola or hyperbola.

7. An electronic control unit for controlling an angular-position measurement sensor, said measurement sensor-being configured to be mounted in a vehicle comprising an internal combustion engine, said engine comprising at least one camshaft, said electronic control unit comprising:
a toothed target, fixed to the at least one camshaft of the engine and comprising on its periphery a plurality of teeth-having uneven angular lengths, each tooth having a leading edge and a trailing edge,
a sensitive element, configured to emit a signal the variations of which are indicative of the passage of the leading edges and of the trailing edges of the teeth, said electronic control unit containing, in memory, for each edge of the toothed target, a set of predetermined “nominal” time intervals (Tnom,n), a set of nominal ratios (Rnom,n) and at least one “reverse” time interval (Tinv,n) which has been predetermined from a theoretical model of the speed of reverse rotation of the camshaft, said model having been created in advance using measurements from a camshaft of a calibration engine rotating in the reverse direction, and said control unit being configured to
receive the signal the variations of which are indicative of the passage of the leading edges and of the trailing edges of the teeth,
determine an identification time interval (Tn) between two successive edges and to store said identification time interval (Tn) in memory,
determine a theoretical edge corresponding to a variation in the received signal,
calculate an identification ratio (Rmes,n) from a plurality of determined identification time intervals (Tn),
calculate a reverse ratio (Rinv,n) from a plurality of nominal time intervals (Tnom,n) and from a reverse time interval (Tinv,n) stored in memory,
compare the identification ratio (Rmes,n) against the nominal ratio (Rnom,n) and against the reverse ratio (Rinv,n),
validate the nominal direction of rotation of the camshaft and the edge when the identification ratio (Rmes,n) is closer to the expected nominal ratio (Rnom,n) than to the reverse ratio (Rinv,n),
detect a reverse rotation of the camshaft and interrupt the injection of fuel into the engine when the identification ratio (Rmes,n) is closer to the reverse ratio (Rinv,n) than to the expected nominal ratio (Rnom,n).

8. The electronic control unit according to claim 7, containing in memory the edges liable to succeed a reversal of the direction of rotation of the camshaft, and calculating a reverse ratio (Rinv,n) only if the expected edge is liable to succeed a reversal of the direction of rotation of the camshaft.

9. The electronic control unit according to claim 8, containing in memory a reverse time interval (Tinv,n) for each edge liable to succeed a reversal of the direction of rotation of the camshaft and configured to calculate the reverse ratio (Rinv,n) for an edge from the reverse time (Tinv,n) corresponding to said edge.

10. An angular-position measurement sensor for a vehicle comprising an internal combustion engine comprising at least one camshaft, said measurement sensor comprising:
a toothed target, fixed to the at least one camshaft of the engine and comprising on its periphery a plurality of teeth-having uneven angular lengths, each tooth having a leading edge and a trailing edge,
a sensitive element, configured to emit a signal the variations of which are indicative of the passage of the leading edges and of the trailing edges of the teeth, and
an electronic control unit according to claim 7.

11. An automotive vehicle, comprising an internal combustion engine, said internal combustion engine comprising at least one camshaft and an angular-position measurement sensor according to claim 10.
